(19) United States
(12) Patent Application Publication
(10) Pub. No.: US 2025/0010234 A1
(43) Pub. Date: Jan. 9, 2025

(54) Scrubber Device for Scrubbing Hydrocarbon Gas Stream

(71) Applicant: 2376016 ALBERTA INC., Calgary (CA)

(72) Inventor: Lester Thiessen, Neilburg (CA)

(21) Appl. No.: 18/731,601

(22) Filed: Jun. 3, 2024

Related U.S. Application Data
(60) Provisional application No. 63/512,108, filed on Jul. 6, 2023.

(51) Int. Cl. B01D 47/02

(52) U.S. Cl. CPC B01D 47/021; B01D 2257/304; B01D 2258/02

(57) ABSTRACT

A device for scrubbing a waste gas from a gas stream has a scrubbing chamber containing an operating level of the scrubbing solution. A manifold is supported in the scrubbing chamber at an intermediate location partway between two opposing ends of the scrubbing chamber to receive the gas stream. Sparger pipes extend longitudinally from the manifold in two opposing directions from opposing sides of the manifold towards the two opposing ends of the scrubbing chamber with discharge openings below the operating level of scrubbing solution for discharging the gas stream from the manifold into the scrubbing solution. Locating the manifold at an intermediate location with sparger pipes extending in opposing directions reduces the distance travelled by the gas along each sparger pipe to minimize pressure loss and maximize gas distribution from the sparger pipes.

This application claims the benefit under 35 U.S.C. 119 (e) of U.S. provisional application Ser. No. 63/512,108, filed Jul. 6, 2023.

### FIELD OF THE INVENTION

The present invention relates to a scrubber device for passing a gas stream through a liquid scrubbing solution to remove a waste gas from the gas stream, and more particularly the present invention relates to a scrubber device for scrubber a waste gas, for example hydrogen sulfide, from a gas stream derived from produced hydrocarbons.

### BACKGROUND

In the production of hydrocarbons from a well, the produced fluids commonly include a mixture of water, oil and various gasses. Subsequent oil refining processes performed on the produced fluids commonly produce a gas stream that includes various toxic waste gases, for example hydrogen sulfide. Various scrubbing technologies exist to assist in removing toxic waste gases from the gas stream, for example by bringing the gas stream into contact with liquid or dry chemicals. Dry systems are hard to clean out and are dangerous due to the buildup of absorbed gases in the dry pellets.

In a liquid scrubbing system, the gas stream is typically discharged from a sparger pipe supported to span a length of the scrubbing chamber while being submerged within a scrubbing solution in the scrubbing chamber. The head pressure of the liquid in some instances can cause too much back pressure on the gas stream being discharged from the sparger pipe such that the gases are primarily discharged in high volumes from the inlet end of the sparger pipe where pressure is greatest so that some of the gases escape the depth of the scrubbing solution before reaching the end of the sparger pipe, which in higher flow situations would still reach the atmosphere without being absorbed by the scrubber solution.

### SUMMARY OF THE INVENTION

According to one aspect of the invention there is provided a gas scrubber device for scrubbing a waste gas from a gas stream using a scrubbing solution, the device comprising:
a scrubbing chamber arranged to contain an operating level of the scrubbing solution therein;
a manifold supported in the scrubbing chamber adjacent a bottom of the scrubbing chamber at an intermediate location partway between two opposing ends of the scrubbing chamber;
a gas inlet passage arranged to direct the gas stream into the manifold;
a plurality of sparger pipes extending longitudinally from the manifold in two opposing directions from opposing sides of the manifold towards the two opposing ends of the scrubbing chamber respectively, each sparger pipe being in open communication with the manifold to receive the gas stream from the manifold, and each sparger pipe including a plurality of discharge openings formed therein below the operating level of the scrubbing solution so as to be arranged to discharge the gas stream into the scrubbing solution in the scrubbing chamber; and
a discharge passage in communication with the scrubbing chamber above the operating level of the scrubbing solution so as to be arranged to discharge the gas stream from the scrubbing chamber subsequent to the gas stream passing through the scrubbing solution.

By locating the manifold at an intermediate location within the scrubbing chamber, with sparger pipes extending in two opposing directions from the manifold, the distance travelled by the gas along each sparger pipe is reduced to minimize pressure loss within the sparger pipes while still maximizing the gas distribution area of the sparger pipes collective to the scrubbing chamber.

When the scrubbing chamber is elongated in a longitudinal direction extending between said two opposing ends of the scrubbing chamber, the sparger pipes preferably extend from the manifold in said longitudinal direction of the tank.

The manifold may be centered between said opposing ends of the scrubbing chamber.

The manifold may be elongated in a lateral direction extending perpendicularly to a longitudinal direction of the scrubbing chamber. In this instance, the sparger pipes are preferably joined to the manifold at evenly spaced apart positions in the lateral direction. The gas inlet passage preferably communicates with the manifold at a central location in the lateral direction.

The discharge openings are preferably situated only in a bottom half of each sparger pipe.

A distance between each sparger pipe and the bottom of the scrubbing tank is preferably less than a height of each sparger pipe. More particularly, a distance between each discharge opening of the sparger pipes and the bottom of the scrubbing tank is preferably less than a height of each sparger pipe.

### BRIEF DESCRIPTION OF THE DRAWINGS

One embodiment of the invention will now be described in conjunction with the accompanying drawings in which:

FIG. 1 is a perspective view of the gas scrubber device;

FIG. 2 is a partly sectional top view of the gas scrubber device along the line 2-2 in FIG. 1; and

FIG. 3 is a partly section side elevational view of the gas scrubber device according to FIG. 1.

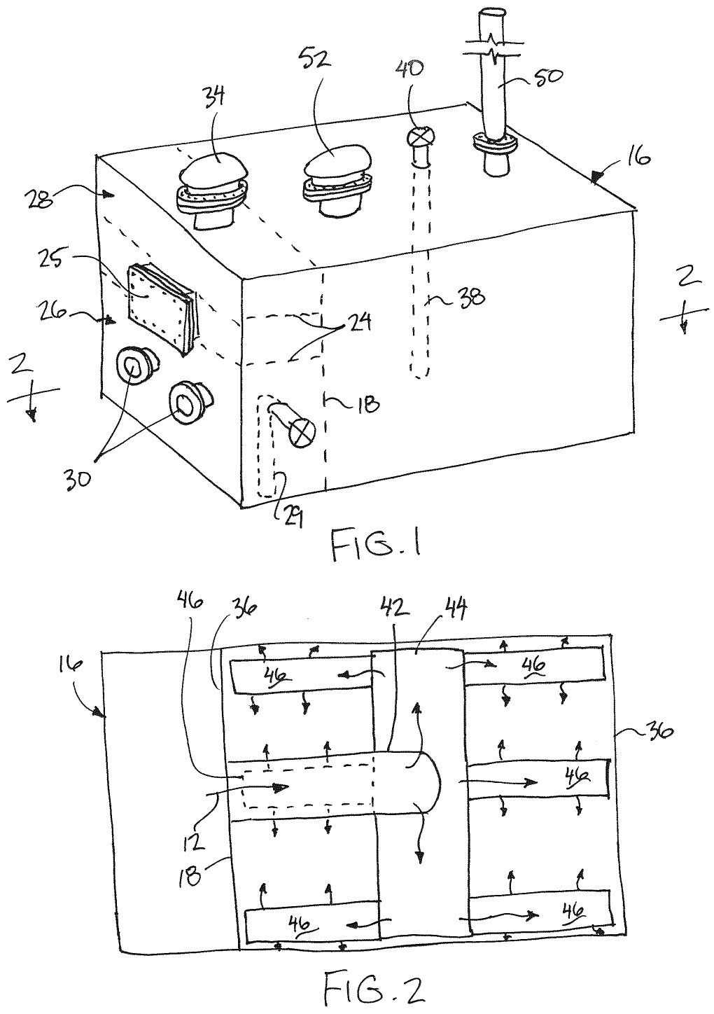

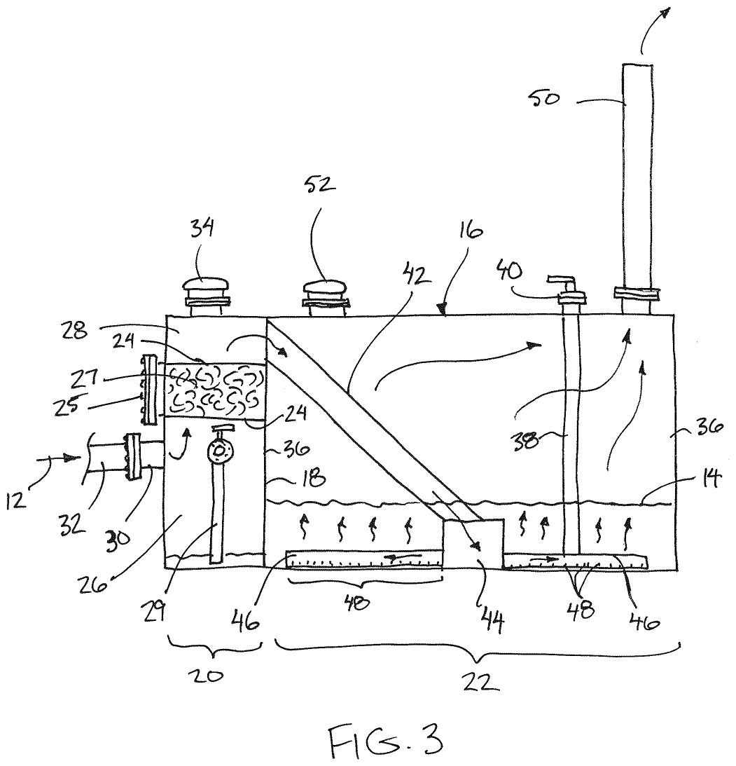

In the drawings like characters of reference indicate corresponding parts in the different figures.

### DETAILED DESCRIPTION

Referring to the accompanying figures, there is illustrated a gas scrubber device generally indicated by reference numeral 10. The device 10 is particularly suited for scrubbing a waste gas from a gas stream 12 using a liquid scrubbing solution 14, for example scrubbing hydrogen sulfide from other gaseous products derived from produced hydrocarbon fluids from a wellbore.

The device 10 is typically used downstream from a gas separator device which separates the gas stream from the remaining oil and water in the produced hydrocarbon fluids. Once separated, the gas stream 12 is directed into the device 10 to pass through the scrubbing solution 14 before discharging the scrubbed gas stream to downstream equipment or to the atmosphere depending upon the application. The scrubber solution is a chemical solution arranged to capture hydrogen sulfide or other waste gases including toxic gases and the like.

The device 10 generally includes a rectangular housing 16 including a divider 18 mounted therein to separate the hollow interior of the housing into a preparation chamber 20 at one end of the housing and a scrubbing chamber 22 on the other side of the divider 18 to span the majority of the length of the housing toward the opposing end of the housing.

The preparation chamber 20 is tall and narrow to span the full height of the housing at one end of the housing. A pair of porous boundary walls 24 span horizontally across the preparation chamber at vertically spaced positions at an intermediate location to define a demisting section of the preparation chamber between the boundary walls 24. The demisting section spans the full width and length of the preparation chamber such that upward flow of gas through the preparation chamber must pass through the demisting section between the boundary walls 24 from the bottom into the top end of the housing.

The demisting section between the boundary walls 24 can be accessed from the exterior of the housing through an access opening 25 in the end wall of the housing which is selectively enclosed by a removable access panel 25. Removing the access panel allows access to the interior of the demisting section. The interior of the demisting section is filled with a porous and/or conductive material 27, for example steel wool upon which moisture in the gas stream can readily condense while allowing the gas stream to pass through. The material 27 can be serviced and replaced through the access panel 25 as required. As the gas stream communicates upwardly through the material 27 in the demisting section, any moisture in the gas stream tends to condense on the material so that the condensed water subsequently drips downwardly to the bottom of the inlet section 26 of the preparation chamber while the gas stream continues upwardly to the upper section 28 of the preparation chamber.

A suction tube 29 communicates through a side wall of the housing 16 between an external end that is enclosed by a suitable valve and an internal end which is an open communication with the interior of the inlet section 26 of the preparation chamber directly adjacent the bottom end thereof. In this manner, when it is desired to remove collected condensate at the bottom of the preparation chamber, suitable vacuum equipment can be connected to the valve at the exterior of the suction tube 29 so that the condensate can be vacuumed out of the preparation chamber through the tube 29 when the valve is opened.

The gas stream enters the preparation chamber at an inlet section 26 below the demisting section so that the gas stream is subsequently directed upwardly from the inlet section through the demisting section to an upper section 28 at the top of the preparation chamber of the housing. A pair of gas intake pipes 30 communicate through the end wall of the housing 16 for directing the gas stream therethrough into the inlet section. Each gas intake pipe 30 includes an external flange formed thereon for connection to a suitable supply pipe 32 which supplies the separated gas stream to the device 10.

An access hatch 34 is mounted in the top wall of the housing in communication with the upper section of the preparation chamber 20 therebelow. The access hatch 34 provides further access when required for servicing the interior of the device, but remains fully closed during normal operation of the device 10.

The scrubbing chamber 22 is elongate in a longitudinal direction of the housing to extend between two longitudinally opposed ends 36 of the chamber. The scrubbing chamber 22 has a greater dimension in the longitudinal direction between the ends 36 than the corresponding width in a lateral direction perpendicular to the longitudinal direction. The resulting bottom of the chamber is flat and rectangular in shape. The floor is sealed to respective upright walls of the chamber about the full perimeter thereof such that the chamber is well-suited for containing an operating level of the scrubbing solution 14 therein. The scrubbing solution is typically filled into the scrubbing chamber such that the operating level is a small fraction of the overall height of the chamber. For example, when the chamber is several feet in height, the operating level of scrubbing solution may be less than 1 foot, and more particularly in the range of 4 inches or less for example. The chamber is also enclosed at the top of the housing to fully enclose the hollow interior of the scrubbing chamber with the exception of the passages communicating through the boundary walls of the chamber as described in the following.

The scrubbing solution is supplied to the scrubbing chamber and/or removed from the scrubbing chamber through a suitable chemical tube 38 communicating through the top boundary wall of the housing. A suitable valve 40 is mounted in communication with the top end of the tube 38 above the housing to control external access to the tube 38. The valve 40 enables a supply line to be connected to the tube 38 for filling the chamber with solution, or a vacuum line to be connected to the tube 38 for withdrawing solution from the chamber. The chemical tube 38 extends downwardly through the interior of the scrubbing chamber to a bottom end of the tube which is in open communication with the chamber directly adjacent the bottom of the chamber.

A supply duct 42 communicates through the divider 18 in the housing of the device 10 at a laterally centred location to communicate between the upper section of the preparation chamber at one end of the duct and to communicate with a manifold 44 at the bottom of the scrubbing chamber at the opposing end. More particularly, the supply duct 42 is sloped downwardly while extending in the longitudinal direction from the preparation chamber at one end of the scrubbing chamber to a laterally centred and longitudinally centred location within the chamber immediately above the bottom of the chamber.

The manifold 44 comprises an elongate duct which extends perpendicularly to the longitudinal direction of the scrubbing chamber so as to extend in the lateral direction substantially the full width of the scrubbing chamber at a longitudinally centred location. The manifold 44 is in open communication with the supply duct 42 to receive the gas stream from the supply duct therein.

Gas is discharged from the manifold through a set of sparger pipes 46. The sparger pipes 46 are mounted on both of the longitudinally opposing sides of the manifold 44 to extend in the longitudinal direction from the manifold in two opposing directions towards the corresponding two longitudinally opposed ends 36 of the scrubbing chamber. More particularly, a set of three sparger pipes 46 are evenly spaced apart in the lateral direction along each of the opposing sides of the manifold such that the sparger pipes extend in the longitudinal direction parallel to one another. Distal ends of the sparger pipes are located in close proximity to the respective longitudinally opposed ends 36 of the scrubbing chamber respectively. Due to the central location of the manifold, each sparger pipe extends less than half the overall length of the chamber while the overall pattern of sparger pipes 46 cover the majority of the overall length of the chamber.

Each sparger pipe includes a plurality of discharge openings 48 at spaced positions along the bottom of the pipe while the upper half of each sparger pipe remains devoid of openings. All of the holes are thus located closer to the bottom of each sparger pipe than the top end thereof. The sparger pipes are also mounted in close proximity to the bottom of the scrubbing chamber either by being directly abutted with the bottom or being mounted sufficiently close that a distance of the sparger pipes 46 to the bottom of the scrubbing tank is less than an overall height of the individual sparger pipes. More particularly, the discharge openings 48 in the bottom of the sparger pipes are located at a distance from the bottom of the scrubbing tank which is less than the height of the individual sparger pipes.

The arrangement of the centrally located manifold with sparger pipes 46 that receive the gas stream in open communication from the manifold into the pipes results in the gas stream being communicated into the sparger pipes and then subsequently discharged through the discharge openings 48 in the sparger pipes into the surrounding scrubbing solution with a minimum pressure loss in the gas stream. By minimizing the pressure loss, sufficient pressure distribution is achieved across all of the discharge openings 48 of the sparger pipes to enable the gas to be discharged from all discharge openings substantially evenly. Furthermore the location of the discharge openings in close proximity to the bottom of the scrubbing chamber enables the chamber to operate with a very low fluid level resulting in minimal head pressure acting against the discharge of gas from the discharge openings 48 which in turn produces less back pressure on the gas stream passing through the device 10. Enough pressure can thus be maintained within the gas stream, together with the minimal pressure loss due to the central discharge of the supply duct into a centrally located manifold, to further ensure an even distribution of gas from the discharge openings for maximizing contact of the gas with the scrubber solution and thereby ensure that none of the waste gas is able to bypass the scrubbing solution and escape with the gas stream exiting the device.

Once the gas stream has been scrubbed by passing through the scrubbing solution at the bottom of the chamber, the gas stream continues to flow upwardly above the operating level of scrubbing solution for subsequent discharge from the housing through a suitable exhaust stack 50 that communicates through the top boundary wall of the scrubbing chamber and continues to extend vertically upward from the housing to an open top end from which the gas stream is discharged to atmosphere or to additional downstream equipment.

A second access hatch 52 is also mounted to communicate through the top boundary wall of the separating chamber. The access hatch 52 normally remains sealed closed during normal use of the device 10; however, the access hatch 52 can be opened to provide access to the interior of the chamber for servicing and maintenance and the like for example.

Since various modifications can be made in the invention as herein above described, and many apparently widely different embodiments of same made, it is intended that all matter contained in the accompanying specification shall be interpreted as illustrative only and not in a limiting sense.

1. A gas scrubber device for scrubbing a waste gas from a gas stream using a scrubbing solution, the device comprising:
a scrubbing chamber arranged to contain an operating level of the scrubbing solution therein;
a manifold supported in the scrubbing chamber adjacent a bottom of the scrubbing chamber at an intermediate location partway between two opposing ends of the scrubbing chamber;
a gas inlet passage arranged to direct the gas stream into the manifold;
a plurality of sparger pipes extending longitudinally from the manifold in two opposing directions from opposing sides of the manifold towards the two opposing ends of the scrubbing chamber respectively, each sparger pipe being in open communication with the manifold to receive the gas stream from the manifold, and each sparger pipe including a plurality of discharge openings formed therein below the operating level of the scrubbing solution so as to be arranged to discharge the gas stream into the scrubbing solution in the scrubbing chamber; and
a discharge passage in communication with the scrubbing chamber above the operating level of the scrubbing solution so as to be arranged to discharge the gas stream from the scrubbing chamber subsequent to the gas stream passing through the scrubbing solution.

2. The device according to claim 1 wherein the scrubbing chamber is elongated in a longitudinal direction extending between said two opposing ends of the scrubbing chamber and wherein the sparger pipes extend from the manifold in said longitudinal direction of the tank.

3. The device according to claim 1 wherein the manifold is centered between said opposing ends of the scrubbing chamber.

4. The device according to claim 1 wherein the manifold is elongated in a lateral direction extending perpendicularly to a longitudinal direction of the scrubbing chamber.

5. The device according to claim 4 wherein the sparger pipes are joined to the manifold at evenly spaced apart positions in the lateral direction.

6. The device according to claim 4 wherein the gas inlet passage communicates with the manifold at a central location in the lateral direction.

7. The device according to claim 1 wherein the discharge openings are situated only in a bottom half of each sparger pipe.

8. The device according to claim 1 wherein a distance between each sparger pipe and the bottom of the scrubbing tank is less than a height of each sparger pipe.

9. The device according to claim 1 wherein a distance between each discharge opening of the sparger pipes and the bottom of the scrubbing tank is less than a height of each sparger pipe.
